(19) United States
(12) Patent Application Publication
(10) Pub. No.: US 2009/0043660 A1
(43) Pub. Date: Feb. 12, 2009

(54) METHOD AND SYSTEM FOR DISPLAYING ADVERTISEMENT

(75) Inventor: Woosung Lee, Seoul (KR)

Correspondence Address: HUSCH BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 12/187,883

(22) Filed: Aug. 7, 2008

(30) Foreign Application Priority Data
Aug. 8, 2007 (KR) 10-2007-0079620

(51) Int. Cl. G06Q 30/00

(52) U.S. Cl. 705/14

(57) ABSTRACT

Disclosed is a method and system for displaying an advertisement which can display an advertisement related to a target page and effectively uses an advertisement inventory. The method for displaying an advertisement according to the present invention includes selecting at least one advertisement that is relevant to a target page based on a predetermined rule among advertisements from at least one contextual advertisement database and at least one keyword advertisement database; and displaying a predetermined number of the first selected advertisement in the target page, wherein the target page is an external publisher page.

### CROSS-REFERENCE TO RELATED APPLICATION

This application claims the benefit of Korean Patent Application No. 10-2007-0079620, filed on Aug. 8, 2007, in the Korean Intellectual Property Office, the disclosure of which is incorporated herein by reference.

### BACKGROUND OF THE INVENTION

1. Field of the Invention

The present invention relates to a method and system for effectively using an advertisement inventory and displaying an advertisement related to a target page.

2. Description of Related Art

Nowadays, an information search through a communication network has become common along with development of the communication network, such as the Internet, and the like. That is, a user may simply obtain desired information using the Internet whenever and wherever the user desires and the information search brings many changes throughout our lives.

The Internet is used as a popular communication means beyond national borders, and the number of users is growing. Accordingly, services for the Internet users are also increased.

Particularly, an advertisement service targeting the users among the service is an essential for running a web site. Accordingly, there are many payment models of advertisement costs between a host providing a search service to an Internet user and an advertiser displaying its information site to the Internet users so as to obtain advertising impact.

That is, in a search service using a search engine, there are many payment models of advertisement costs which include extracting information of an advertiser, displaying information extracted from the advertiser, and billing the displayed information of the advertiser.

However, an unsold advertising region remains in an inventory of the Internet advertisement. Particularly, in many cases, the unsold advertising region is in a web banner advertisement inventory and the like. Therefore, an advertisement business may be realized using the unsold advertising region. However, an advertisement is not usually displayed in the unsold advertising region, and thus, there are problems of waste of advertisement inventory and failing in increasing additional sales. That is, the conventional advertisement inventory is inefficiently used.

### BRIEF SUMMARY OF THE INVENTION

An aspect of the present invention provides an advertisement displaying method and system which can display an advertisement in an unsold advertising region of a web banner advertisement inventory, and the like, thereby effectively using the advertisement inventory.

Another aspect of the present invention also provides an advertisement displaying method and system which can display an advertisement with high relevancy to a target page.

Another aspect of the present invention also provides an advertisement displaying method and system which can develop a new advertisement inventory and enlarge the advertisement inventory, thereby anticipating an increase of advertisement sales.

Another aspect of the present invention also provides an advertisement displaying method and system which can display an advertisement with high relevancy to a user interest, thereby increasing advertisement service usage rate of a user, and also increasing a request for advertisement service from an advertiser.

Another aspect of the present invention also provides an advertisement displaying method and system which shares advertisement revenue with an external publisher, the advertisement revenue being obtained from displaying an advertisement in an external publisher page.

According to an aspect of the present invention, there is provided a method for displaying an advertisement, the method including: selecting at least one advertisement that is relevant to a target page based on a predetermined rule among advertisements from at least one contextual advertisement database and at least one keyword advertisement database; determining advertising revenue derived from each of the first selected advertisement during a predetermined period of time; selecting at least one advertisement among the first selected advertisement based on the advertising revenue; and displaying the second selected advertisement in the target page.

According to another aspect of the present invention, there is provided a method for displaying an advertisement, the method including: selecting at least one advertisement that is relevant to a target page based on a predetermined rule among advertisements from at least one contextual advertisement database and at least one keyword advertisement database; and displaying a predetermined number of the first selected advertisement in the target page, wherein the target page is an external publisher page.

According to another aspect of the present invention, upon receipt of a search request including at least one search query from a user, at least one predetermined query is extracted from the at least one search query and the target page is analyzed to determine whether the target page matches with the predetermined query included in the search query.

According to another aspect of the present invention, a relevancy score indicating a relevancy of the advertisement to the target page is assigned to each of the first selected advertisement and at least one advertisement is selected based on the assigned relevancy score.

According to another aspect of the present invention, the second selected advertisement is displayed in at least one of an unsold inventory region of a web banner advertisement, a keyword advertisement region excluding an integrated search, and a product search advertisement affiliated region. In another embodiment, the at least one advertisement corresponding to a category or sub-category of the target page is selected. To select the at least one advertisement corresponding to a category or sub-category of the target page, the method comprises the steps of: mapping, with respect to a name of the sub-category, a predetermined keyword recommend by a search word auto complete function to the sub-category; assigning to each of advertisements related to the mapped keyword, a relevancy score indicating relevancy of the advertisement to the target page; and selecting a predetermined number of advertisements based on the assigned relevancy score.

According to another aspect of the present invention, the step of selecting at least one advertisement that is relevant to a target page based on a predetermined rule comprises the step of: verifying whether cookie information exists in a user terminal; identifying at least one search query retrieved during a predetermined period in the cookie information; and selecting at least one keyword advertisement related to the search query.

According to another aspect of the present invention, the step of selecting the keyword advertisement comprises the steps of: assigning, to each of the keyword advertisements related to the search query, a relevancy score indicating relevancy of the keyword advertisement to the target page; and selecting a predetermined number of keyword advertisements based on the assigned relevancy score.

According to another aspect of the present invention, the step of selecting at least one advertisement that is relevant to a target page based on a predetermined rule comprises the step of: verifying whether a category of a page view exceeding a predetermined standard exists in the log-in cookie; mapping, when a category of a page view exceeding a predetermined standard exists, a predetermined keyword recommend by a search word auto complete function to the category, with respect to a name of a category of a maximum page view among the categories; assigning, to each of the keyword advertisements related to the mapped keyword, a relevancy score indicating relevancy of the keyword advertisement to the target page; and selecting a predetermined number of keyword advertisements based on the assigned relevancy score.

According to another aspect of the present invention, the contextual advertisement database includes a web banner ad database and the keyword advertisement database includes a product search advertisement database.

According to another aspect of the present invention, there is provided a system for displaying an advertisement, the system including: a processor; a memory to communicate with the processor; a selecting module, resident in the memory and executable by the processor, configured to select at least one advertisement that is relevant to a target page based on a predetermined rule among advertisements from at least one contextual advertisement database and at least one keyword advertisement database, to determine advertising revenue derived from each of the first selected advertisement during a predetermined period of time, and to select at least one advertisement among the first selected advertisement based on the advertising revenue; and a displaying module, resident in the memory and executable by the processor, configured to display the second selected advertisements in the target page.

According to another aspect of the present invention, there is provided a system for displaying an advertisement, the system including: a processor; a memory to communicate with the processor; a selecting module, resident in the memory and executable by the processor, configured to select at least one advertisement that is relevant to a target page based on a predetermined rule among advertisements from at least one contextual advertisement database and at least one keyword advertisement database; and a displaying module, resident in the memory and executable by the processor, configured to display a predetermined number of the first selected advertisement in the target page, wherein the target page is an external publisher page.

According to another aspect of the present invention, the selecting module, upon receipt of a search request including at least one search query from a user, extracts at least one predetermined query from the at least one search query and analyzes the target page to determine whether the target page matches with the predetermined query included in the search query.

According to another aspect of the present invention, the selecting module assigns to each of the first selected advertisement, a relevancy score indicating a relevancy of the advertisement to the target page and selects at least one advertisement based on the assigned relevancy score. The displaying module displays the second selected advertisement in at least one of an unsold inventory region of a web banner advertisement, a keyword advertisement region excluding an integrated search, and a product search advertisement affiliated region.

According to another aspect of the present invention, the selecting module selects the at least one advertisement corresponding to a category or sub-category of the target page.

According to another aspect of the present invention, the selecting module verifies whether cookie information exists in a user terminal, identifies at least one search query retrieved during a predetermined period in the cookie information and selects at least one keyword advertisement related to the search query.

According to another aspect of the present invention, the selecting module verifies whether a category of a page view exceeding a predetermined standard exists in the log-in cookie, maps, when a category of a page view exceeding a predetermined standard exists, a predetermined keyword recommend by a search word auto complete function to the category, with respect to a name of a category of a maximum page view among the categories, assigns to each of the keyword advertisements related to the mapped keyword, a relevancy score indicating relevancy of the keyword advertisement to the target page, and selects a predetermined number of keyword advertisements based on the assigned relevancy score.

Additional aspects, features, and/or advantages of the invention will be set forth in part in the description which follows and, in part, will be apparent from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIGS. 1 to 3 are flowcharts illustrating a method for displaying an advertisement according to an example embodiment of the present invention;

FIG. 4 illustrates a keyword mapped to a sub-category of FIG. 3;

FIGS. 5 to 8 are flowcharts illustrating a method for displaying an advertisement according to an example embodiment of the present invention;

FIG. 9 illustrates a network configuration of an advertisement server which performs displaying advertisement according to an example embodiment; and

FIG. 10 is a block diagram illustrating the advertisement server of FIG. 9.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

A method and system for displaying an advertisement according to an example embodiment of the present invention may search for an advertisement (such as a keyword advertisement, a product search advertisement, a web banner advertisement, and the like) related to a target page where the advertisement is displayed (hereinafter, a target page) using a search query, a context, a category, a cookie, and the like, assign a relevancy score indicating relevancy to the target page to the retrieved advertisement, and display the retrieved advertisement in the target page based on the assigned relevancy score.

Contextual advertisement is a form of targeted advertising for advertisements appearing on websites or other media, which are selected based on the content displayed to the user. The contextual advertisement database may include a web banner ad database. Keyword advertisement refers to any advertising that is linked to specific words or phrases. The keyword advertisement may be implemented in a search engine or other search function related to shopping web sites, such as a product search. Thus, the keyword advertisement database may include a keyword advertisement database and a product search advertisement database.

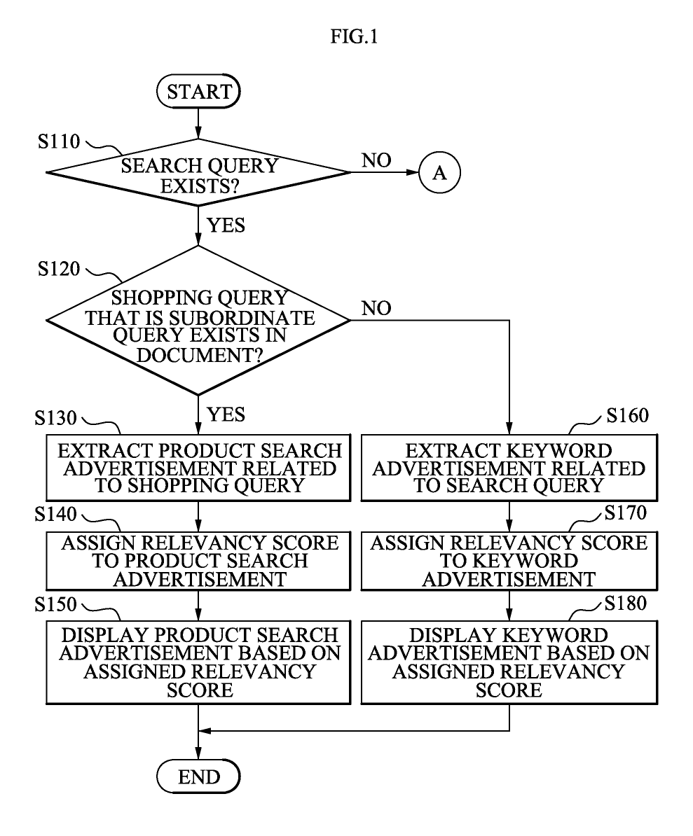

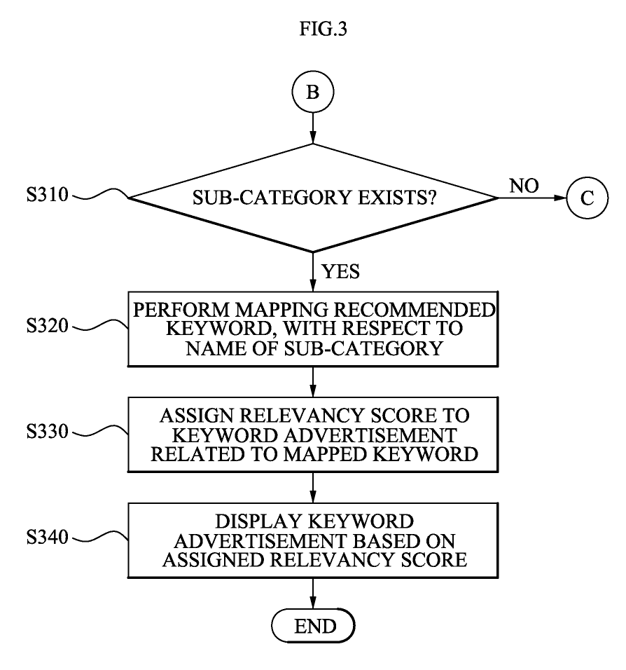

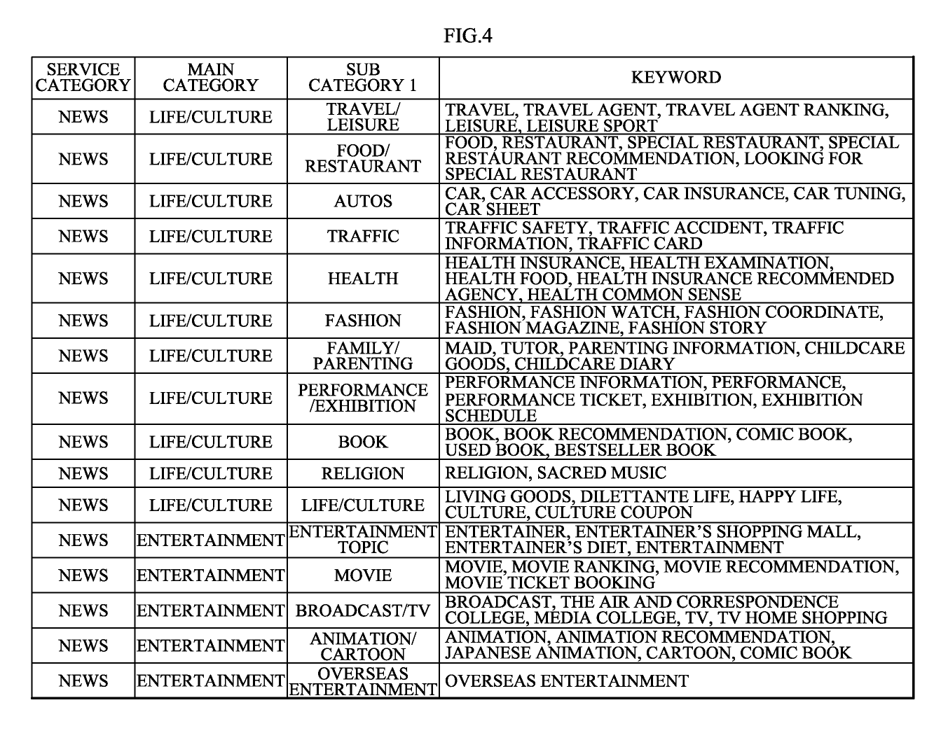

FIGS. 1 to 3 and FIGS. 5 to 8 are flowchart illustrating a method for displaying and advertisement according to an example embodiment of the present invention. Also, FIG. 4 illustrates a keyword mapped in a sub-category of the FIG. 3. For reference, an advertisement server is used as a main body for performing the method of displaying the advertisement in the example embodiment.

First, referring to FIG. 1, the advertisement server verifies whether a search query inputted from a user exists in operation S110. That is, the advertisement server verifies whether a search query is inputted by the user in a search box of a web page that provides search service through a user terminal.

In operation S120, the advertisement server verifies whether a shopping query that is subordinate to the search query exists in the target page (document). That is, the advertisement server can perform reading text of the target page, and extracting the shopping query from the read text. Therefore, the advertisement server can verify whether the shopping query exists through the extracted shopping query.

In this instance, when the shopping query (e.g. the shopping query is subordinate to the search query) included in the search query is verified to be in the target page, operation S130 is performed. That is, the advertisement server extracts a product search advertisement related to the shopping query in operation S130. To achieve the above, the advertisement server may refer to an advertisement database where a plurality of product search advertisements and shopping queries are mapped and stored, and extract a product search advertisement related to the shopping query.

Next, the advertisement server selects a product search advertisement from among the extracted product search advertisements. That is, the advertisement server may select the top N product search advertisements from among the extracted product search advertisements in an order of highest relevancy to the shopping query. For example, assuming that 10 product search advertisements related to the shopping query are extracted in operation S 130, the advertisement server selects five product search advertisements from among the extracted 10 product search advertisements in an order of highest relevancy to the shopping query.

In operation S140, the advertisement server assigns, to each of the selected product search advertisements, a relevancy score indicating relevancy to the target page. That is, the advertisement server identifies a number of shopping queries according to a type of a shopping query, which is related to the product search advertisement, and existing in the target page, and assigns, based on the number of shopping queries, a relevancy score indicating relevancy to contents in the target page to each of the selected product search advertisements.

As an example, assuming that shopping queries, (1) ‘a cellular phone’, (2) ‘an electronic dictionary’, (3) ‘an MP3 player’, (4) ‘a digital camera’ and (5) ‘a PMP’ are respectively 10, 8, 7, 5, and 4 in the target page, the shopping queries being shopping queries that are related to the product search advertisements, the advertisement server assign, to each of the product search advertisements related to the shopping query, a relevancy score indicating relevancy to contents in the target page as shown below.

(1) a product search advertisement related to ‘a cellular phone’: 10 points

(2) a product search advertisement related to ‘an electronic dictionary’: 8 points

(3) a product search advertisement related to ‘an MP3 player’: 7 points

(4) a product search advertisement related to ‘a digital camera’: 5 points

(5) a product search advertisement related to ‘PMP’: 4 points

In operation S150, the advertisement server may display the top N (where ‘N’ is a natural number) product search advertisements from among the product search advertisements in the target page based on the assigned relevancy score. That is, the advertisement server may display the top N product search advertisements with high relevancy score in the target page. In this instance, the target page may include internal publisher page (e.g. an integrated search result page, a tap search result page, a result page of a search within service, a cafe, a blog, and the like) or an external publisher page (e.g. news, user created contents (UCC), an external blog, and the like).

In the above-mentioned examples, the advertisement server may display product search advertisement with high relevancy score indicating relevancy to contents in the target page, namely, (1) a product search advertisement related to ‘a cellular phone’ and (2) a product search advertisement related to ‘an electronic dictionary’ in the target page. In this instance, the advertisement server may display (1) a product search advertisement related to ‘a cellular phone’ and (2) a product search advertisement related to ‘an electronic dictionary’ in a predetermined region (e.g. an unsold inventory region of web banner advertisement, a keyword advertisement region excluding an integrated search, and a product search advertisement affiliated region) of the target page in an order of highest relevancy score.

Accordingly, the advertisement server may display a product search advertisement with the highest relevancy score in the target page. Also, the advertisement server may display the product search advertisement in the unsold inventory region of the web banner advertisement, and the like, thereby effectively using an advertisement inventory and enlarging an advertisement region. Thus, the advertisement server may provide an additional increase of advertisement sales according to the enlargement of the advertisement region.

Also, when the advertisement is displayed in the external publisher page, the advertisement server may share advertising revenue obtained from the displaying with an external publisher who provides the external publisher page.

Conversely, when the shopping query that is subordinate to the search query does not exist in the target page in operation S120, the advertisement server may perform operation S160.

That is, in operation S160, the advertisement server extracts a keyword advertisement related to the search query. To perform the above, the advertisement server refers to an advertisement database where a plurality of keyword advertisements and search queries are mapped and stored, and extracts the keyword advertisement related to the search query.

Next, the advertisement server selects a keyword advertisement from among the extracted keyword advertisements. That is, the advertisement server may select the top N (where ‘N’ is a natural number) keyword advertisements from among the extracted keyword advertisements in an order of highest relevancy to the search query. For example, assuming that 10 keyword advertisements related to the search query are extracted in operation S160, the advertisement server selects the top five keyword advertisements from among the extracted 10 keyword advertisements in an order of highest relevancy to the search query.

In operation S170, the advertisement server assigns, to each of the selected keyword advertisements, a relevancy score indicating relevancy to the target page. That is, the advertisement server identifies a number of search queries according to a type of a search query existing in the target page, and assigns, based on the number of search queries, a relevancy score indicating relevancy to contents in the target page to each of keyword advertisements.

As an example, assuming that search queries, (1) ‘a cellular phone’, (2) ‘an electronic dictionary’, (3) ‘an MP3 player’, (4) ‘a digital camera’ and (5) ‘a PMP’ are respectively 10, 8, 7, 5, and 4 in the target page, the search queries being search queries that are related to the search queries, the advertisement server assign, to each of the web banner advertisements related to the search query, a relations score indicating relevancy to contents in the target page as shown below.

(1) a product search advertisement related to ‘a cellular phone’: 10 points

(2) a product search advertisement related to ‘an electronic dictionary’: 8 points

(3) a product search advertisement related to ‘an MP3 player’: 7 points

(4) a product search advertisement related to ‘a digital camera’: 5 points

(5) a product search advertisement related to ‘PMP’: 4 points

Also, alternatively, the advertisement server may calculate a Click Choice Index (CCI) of each keyword advertisement related to the search query using maximum click cost and a score for managing advertisements, and assign, to each of the keyword advertisements, a relevancy score indicating relevancy to contents in the target page based on the calculated CCI. In this instance, the CCI, obtained by multiplying maximum click cost of corresponding keyword advertisement and advertisement management score (CCI=maximum click cost*advertisement management score), can be used as a standard when assigning the relevancy score to the keyword advertisement.

For example, assuming that CCI of (1) a keyword advertisement related to ‘a cellular phone’, (2) a keyword advertisement related to ‘an electronic dictionary’, (3) a keyword advertisement related to ‘an MP3 player’, (4) a keyword advertisement related to ‘a digital camera’, and (5) a keyword advertisement related to ‘a PMP’ are respectively 230, 225, 220, 218, and 215. In this instance, the advertisement server may respectively assign a relevancy score, 10, 9, 8, 6, and 5 to (1) a keyword advertisement related to ‘a cellular phone’, (2) a keyword advertisement related to ‘an electronic dictionary’, (3) a keyword advertisement related to ‘an MP3 player’, (4) a keyword advertisement related to ‘a digital camera’, and (5) a keyword advertisement related to ‘a PMP’. That is, the advertisement server may assign a relevancy score indicating relevancy to contents in the target page according to the CCI of each keyword advertisement.

In operation S180, the advertisement server may display the top N (where ‘N’ is a natural number) keyword advertisements in the target page from among the keyword advertisements based on the assigned relevancy score. That is, the advertisement server may display the top N (where ‘N’ is a natural number) keyword advertisements with high relevancy score in the target page. In this instance, the target page may include internal publisher page (e.g. an integrated search result page, a tap search result page, a result page of a search within service, a cafe, a blog, and the like) or an external publisher page (e.g. news, UCC, an external blog, and the like).

In the above-mentioned examples, the advertisement server may display keyword advertisements with high relevancy score indicating relevancy to contents in the target page, namely, (1) a keyword advertisement related to ‘a cellular phone’ and (2) a keyword advertisement related to ‘an electronic dictionary’ in the target page. In this instance, the advertisement server may display (1) a keyword advertisement related to ‘a cellular phone’ and (2) a keyword advertisement related to ‘an electronic dictionary’ in a predetermined region (e.g. an unsold inventory region of web banner advertisement, a keyword advertisement region excluding an integrated search, and a product search advertisement affiliated region) of the target page in an order of highest relevancy score.

Accordingly, the advertisement server may display a keyword advertisement with the highest relevancy score in the target page. Also, the advertisement server may display the keyword advertisement in the unsold inventory region of the web banner advertisement, and the like, thereby effectively using an advertisement inventory and enlarging an advertisement region. Thus, the advertisement server may provide an additional increase of advertisement sales according to the enlargement of the advertisement region.

Also, when the advertisement is displayed in the external publisher page, the advertisement server may share advertising revenue obtained from the displaying with an external publisher who provides the external publisher page.

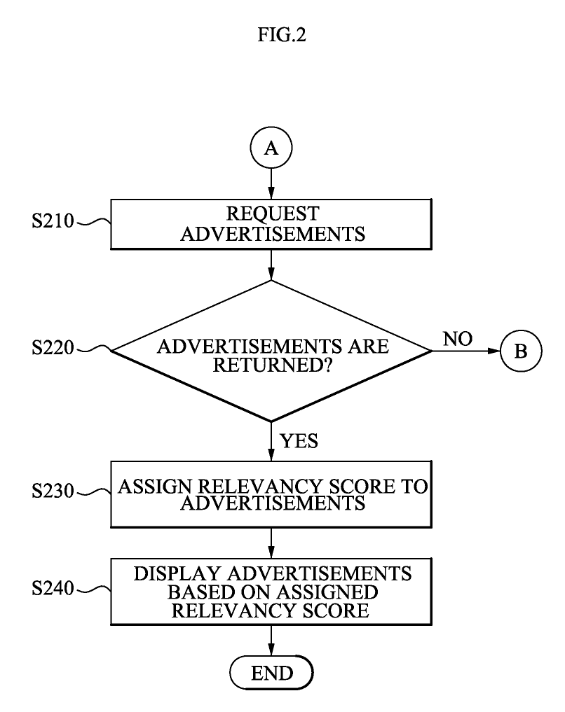

Meanwhile, when the advertisement server verifies that the search query inputted from the user does not exist in operation S110, the advertisement server performs operations as shown in FIG. 2.

That is, referring to FIG. 2, the advertisement server send a request for an advertisement to a contextual advertisement engine, a product search advertisement engine, a web banner advertisement engine. In this instance, the advertisement server may request advertisements related to contents in the target page from the contextual advertisement engine, product search advertisement engine, and web banner advertisement engine. Also, the advertisement server may request the advertisements from at least one of the contextual advertisement engine, product search advertisement engine, and web banner advertisement engine.

In operation S220, the advertisement server may verify whether the advertisements are received from the contextual advertisement engine, product search advertisement engine, and web banner advertisement engine in response to the advertisement request. That is, the advertisement server may verify whether a keyword advertisement, a product search advertisement, a web banner advertisement are respectively returned from the contextual advertisement engine, product search advertisement engine, and web banner advertisement engine in response to the advertisement request.

As a result of verifying, when the advertisements are returned, the advertisement server assigns, to the keyword advertisement, product search advertisement, and web banner advertisement, a relevancy score indicating relevancy to contents in the target page in operation S230. To perform the above, the advertisement server may assign high relevancy score to an advertisement with high relevancy to contents in the target page.

Also, alternatively, the advertisement server may calculate a CCI of each advertisement (a keyword advertisement, a product search advertisement, and a web banner advertisement) returned from the contextual advertisement engine, product search advertisement engine, and web banner advertisement engine using maximum click cost and an advertisement management score, and assign, to each of the advertisements, a relevancy score indicating relevancy to contents in the target page based on the calculated CCI.

After that, the advertisement server may adjust the relevancy score by applying a heuristic rule. That is, the advertisement server compares the assigned relevancy score with a value obtained from experience-based learning (experiential value) to derive a suitable value (relevancy score), thereby adjusting the relevancy score.

Accordingly, the advertisement server may assign to each of the advertisements, a relevancy score which is adjusted to an improved value.

Therefore, the advertisement server may satisfy an environment to display an advertisement with higher relevancy to the target page.

In operation S240, the advertisement server may display the top N (where ‘N’ is a natural number) advertisements from among the advertisements (a keyword advertisement, a product search advertisement, and a web banner advertisement) in the target page based on the assigned relevancy score. That is, the advertisement server may display the top N advertisements including keyword advertisements, product search advertisements, or web banner advertisements in the target page based on each relevancy score of the keyword advertisement, product search advertisement, and web banner advertisement. In this instance, the target page may include an internal publisher page (e.g. text-based page excluding a search query) or an external publisher page (e.g. news, UCC, an external blog, and the like).

In this case, the advertisement server may display the advertisements in a predetermined region (e.g. an unsold inventory region of web banner advertisement, a keyword advertisement region excluding an integrated search, and a product search advertisement affiliated region) of the target page in an order of highest relevancy score.

Accordingly, the advertisement server may display an advertisement with high relevancy to the target page in the target page. Also, the advertisement server displays the advertisement in the unsold inventory region of the web banner advertisement, and the like, thereby effectively using an advertisement inventory and enlarging an advertisement region.

Thus, the advertisement server may provide an additional increase of advertisement sales according to the enlargement of the advertisement region.

Also, when the advertisement is displayed in the external publisher page, the advertisement server may share advertising revenue obtained from the displaying with an external publisher who provides the external publisher page.

Meanwhile, when the advertisement server verifies that the advertisement is not returned from the contextual advertisement engine, product search advertisement engine, and web banner advertisement engine in operation S220, the advertisement server performs operations as shown in FIG. 3.

That is, referring to FIG. 3, the advertisement server verifies whether a sub-category of a predetermined category exists. In particular, the advertisement server may verify whether a top category has a sub-category more than a Depth 2 level. In this instance, the category may indicate a category related to the target page. For example, the advertisement server may verify whether the top category, ‘news’ category has the sub-category, ‘autos’ category, more than the Depth 2 level.

As a result of verifying, when the sub-category exists, the advertisement server performs mapping, with respect to a name of the sub-category, a keyword recommended by a search word auto complete function to the sub-category in operation S320. In this instance, the advertisement server may perform mapping a commercial keyword among the recommended keywords to the sub-category.

For example, as shown in FIG. 4, the top category, a ‘news’ category, which is in a Depth 1 level, has the sub-category, such as ‘life/culture’, and ‘entertainment’, and the sub-category ‘life/culture’, which is in a Depth 2 level, has a sub-category, such as a ‘travel/leisure’, a ‘food/restaurant’, a ‘autos’, a ‘traffic’, a ‘health’, a ‘fashion’, a ‘family/parenting’, a ‘performance/exhibition’, a ‘book’, a ‘religion’, and a ‘lifestyle/culture’.

In the above example, the advertisement server may perform mapping, with respect to a name of the category, ‘autos’, which is one of sub-categories in the Depth 2 level of the ‘news’ category, a commercial keyword among keywords recommended by a search word auto complete function, such as a ‘car’, a ‘car accessory’, a ‘car insurance’, ‘car tuning’, and a ‘car sheet’ to the ‘autos’ sub-category. Also, the advertisement server may perform mapping, with respect to a name of the category, ‘family/parenting’, which is one of sub-categories in the Depth 2 level of the ‘news’ category, a commercial keyword among keywords recommended by the search word auto complete function, such as ‘a maid’, ‘a tutor’, ‘parenting information’, ‘childcare goods’, and ‘childcare diary’ to the family/parenting’ sub-category. In the above-examples, although a number of the keywords mapped to the sub-category is limited to five for ease of description and for ease of comprehension of the invention, the number of the keywords is not limited to the above examples and the number of the keywords may be more or less than the example.

In operation S330, the advertisement server assigns, to each keyword advertisement related to the mapped keyword, a relevancy score indicating relevancy to contents in the target page. To perform the above, the advertisement server may estimate relevancy between the keyword and the target page through a predetermined algorithm, and assign the relevancy score to each keyword advertisement based on the estimated relevancy. In this instance, the predetermined algorithm may include a relevancy estimation algorithm using a word, a context, a category, and the like.

Also, alternatively, the advertisement server calculates a CCI of each keyword advertisement related to the keyword using a maximum click cost and an advertisement management score, and assigns, to each keyword advertisement, a relevancy score indicating relevancy to contents in the target page based on the calculated CCI.’

In operation S340, the advertisement server may display the top N (where ‘N’ is a natural number) keyword advertisements from among the keyword advertisements in the target page based on the assigned relevancy score. In this instance, the advertisement server may display the top N keyword advertisements in a predetermined region (e.g. an unsold inventory region of web banner advertisement, a keyword advertisement region excluding an integrated search, and a product search advertisement affiliated region) of the target page. In this instance, the target page may include an internal publisher page (e.g. a page of the sub-category which does not include a search query, and also does not include a text-based page) or an external publisher page (e.g. news, UCC, an external blog, and the like).

In particular, the advertisement server may select the top N (where ‘N’ is a natural number) keyword advertisements from among the keyword advertisements based on the assigned relevancy score. For example, the advertisement server may select the top N (where ‘N’ is a natural number) keyword advertisements with assigned high relevancy score from among the keyword advertisements as advertisements to be displayed in the target page. Next, the advertisement server may display the selected N (where ‘N’ is a natural number) keyword advertisements in the target page.

Accordingly, the advertisement server may display an advertisement with high relevancy to the target page in the target page. Also, the advertisement server displays the advertisement in the unsold inventory region of the web banner advertisement, and the like, thereby effectively using an advertisement inventory and enlarging an advertisement region. Thus, the advertisement server may provide an additional increase of advertisement sales according to the enlargement of the advertisement region.

Also, when the advertisement is displayed in the external publisher page, the advertisement server may share advertising revenue obtained from the displaying with an external publisher who provides the external publisher page.

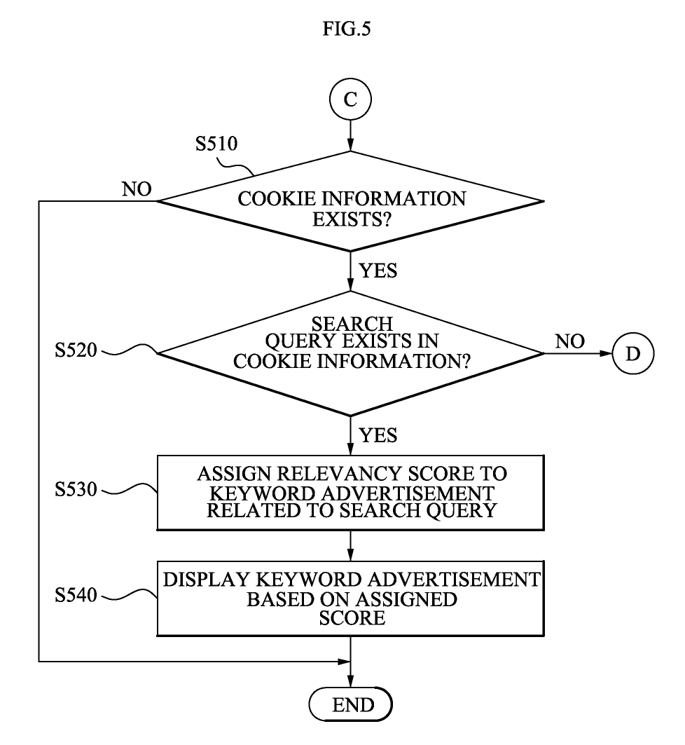

Meanwhile, when the advertisement server verifies that the sub-category of the predetermined category does not exist in operation S310, the advertisement server performs operations as shown in FIG. 5.

That is, referring to FIG. 5, the advertisement server verifies whether cookie information exists in a user terminal in operation S510. In this instance, when the cookie information does not exist in the user terminal, the advertisement server terminates displaying advertisements according to an example embodiment of the present invention.

However, when the cookie information exists in the user terminal, the advertisement server may verify whether a search query retrieved during a predetermined period (e.g. today) exists in the cookie information in operation S520. In this instance, when the search query retrieved during the predetermined period exists in the cookie information, the advertisement server performs operation S530.

That is, in operation S530, the advertisement server extracts a keyword advertisement related to the search query from a keyword advertisement database, and assigns, to each extracted keyword advertisement, a relevancy score indicating relevancy to contents in the target page. To perform the above, the advertisement server identifies a number of search queries retrieved today according to a type of a search query, the search queries existing in the cookie information, and assigns the relevancy score based on the number of search queries. In this instance, the advertisement display database may indicate a storing device for recording the search queries and corresponding keyword advertisements thereto.

Also, alternatively, the advertisement server may calculate a CCI of each keyword advertisement related to the search query using maximum click cost and advertisement management score, and assign the relevancy score to each of the keyword advertisements based on the calculated CCI.

In operation S540, the advertisement server may display the top N (where ‘N’ is a natural number) keyword advertisements from among the keyword advertisements in the target page based on the assigned relevancy score.

In particular, the advertisement server may select the top N (where ‘N’ is a natural number) keyword advertisements from among the keyword advertisements based on the assigned relevancy score. For example, the advertisement server may select the top N (where ‘N’ is a natural number) keyword advertisements with assigned high relevancy score from among the keyword advertisements as advertisements to be displayed in the target page. Next, the advertisement server may display the selected N (where ‘N’ is a natural number) keyword advertisements in the target page.

In this instance, the advertisement server may display the N keyword advertisements in a predetermined region (e.g. an unsold inventory region of web banner advertisement, a keyword advertisement region excluding an integrated search, and a product search advertisement affiliated region) of the target page. In this case, the target page may include an internal publisher page (e.g. a page which is not a page of a sub-category, does not include a search query, and does not include a text-based page) or an external publisher page (e.g. news, UCC, an external blog, and the like). Also, the search query may be inputted by the user in a search box of a web page, or alternatively the search query may be stored in the cookie information today.

Accordingly, the advertisement server may display an advertisement with high relevancy to the target page in the target page. Also, the advertisement server may display the advertisement in the unsold inventory region of the web banner advertisement, and the like, thereby effectively using an advertisement inventory and enlarging an advertisement region. Thus, the advertisement server may provide an additional increase of advertisement sales according to the enlargement of the advertisement region.

Also, when the advertisement is displayed in the external publisher page, the advertisement server may share advertising revenue obtained from the displaying with an external publisher who provides the external publisher page.

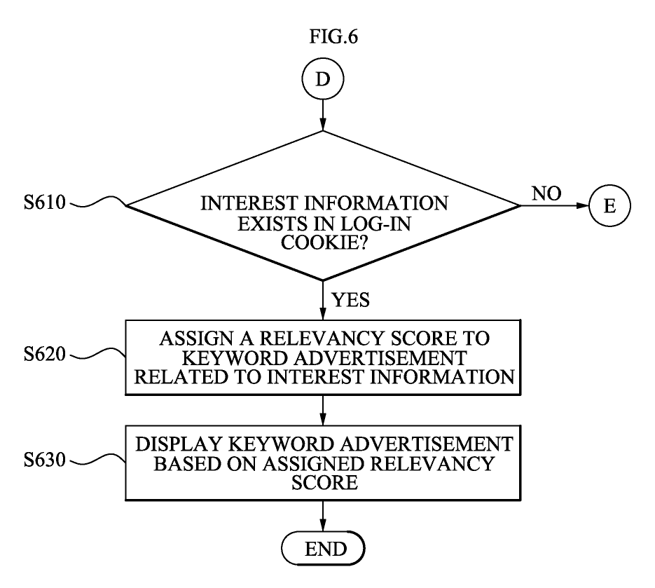

Meanwhile, when the advertisement server verifies the search query retrieved today does not exist in the cookie information in operation S520, the advertisement server performs operations as shown in FIG. 6.

That is, referring to FIG. 6 the advertisement server verifies whether user interest information exists in a log-in cookie stored in a user terminal. In this instance, the log-in cookie may be a log-in cookie that the advertisement server searches by mapping with a browser of the user terminal.

When the interest information exists in the log-in cookie, the advertisement server performs operation S620. That is, in operation S620, the advertisement server assigns, to a keyword advertisement related to the user interest information, a relevancy score indicating relevancy to contents in the target page. To perform the above, the advertisement server may extract the user interest information from the log-in cookie, and retrieve the keyword advertisement related to the interest information from a keyword advertisement database using the extracted interest information. Also, the advertisement server may assign, to each retrieved keyword advertisement, a relevancy score indicating relevancy to contents in the advertisement target page.

In this instance, the advertisement server may assign the relevancy score to each keyword advertisement in an order of highest interest of user for the user interest information. Also, alternatively, the advertisement server may calculate a CCI of each keyword advertisement using maximum click cost and advertisement management score, and assign the relevancy score to each of the keyword advertisements based on the calculated CCI. That is, the advertisement server may differently assign relevancy score to each keyword advertisement in an order of highest CCI.

In operation S630, the advertisement server may display the top N (where ‘N’ is a natural number) keyword advertisements from among the keyword advertisements in the target page based on the assigned relevancy score. That is, the advertisement server may display the top N keyword advertisements with high relevancy score from among the keyword advertisements in the target page.

In particular, the advertisement server may select the top N (where ‘N’ is a natural number) keyword advertisements from among the keyword advertisements based on the assigned relevancy score. For example, the advertisement server may select the top N (where ‘N’ is a natural number) keyword advertisements with assigned high relevancy score from among the keyword advertisements as advertisements to be displayed in the target page. Next, the advertisement server may display the selected N (where ‘N’ is a natural number) keyword advertisements in the target page.

In this instance, the advertisement server may display the N keyword advertisements in a predetermined region (e.g. an unsold inventory region of web banner advertisement, a keyword advertisement region excluding an integrated search, and a product search advertisement affiliated region) of the target page. In this case, the target page may include an internal publisher page (e.g. a page which is not a page of a sub-category, not including a search query, and not a text-based page) or an external publisher page (e.g. news, UCC, an external blog, and the like). Also, the search query may be inputted by the user in a search box of a web page, or alternatively the search query may be stored in the cookie information today.

Accordingly, the advertisement server may display an advertisement with high relevancy to the target page in the target page. Also, the advertisement server may display the advertisement in the unsold inventory region of the web banner advertisement, and the like, thereby effectively using an advertisement inventory and enlarging an advertisement region. Thus, the advertisement server may provide an additional increase of advertisement sales according to the enlargement of the advertisement region.

Also, when the advertisement is displayed in the external publisher page, the advertisement server may share advertising revenue obtained from the displaying with an external publisher who provides the external publisher page.

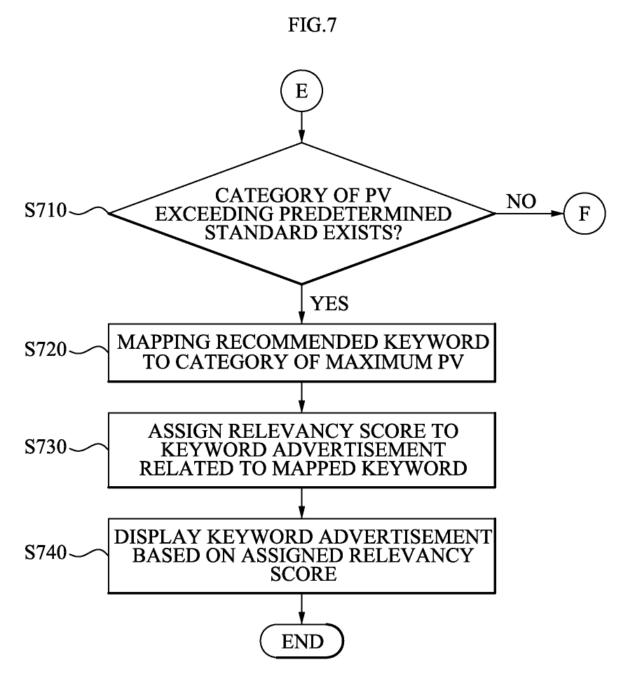

Meanwhile, when the advertisement server verifies that user interest information doest not exist in the log-in cookie stored in the user terminal in operation S610, the advertisement server performs operations as shown in FIG. 7.

That is, referring to FIG. 7, the advertisement server verifies whether a category of a Page View (PV) exceeding a predetermined standard exists in the log-in cookie in operation S710. In this instance, the PV indicates how many times a requested web page is viewed to a visitor (a page accessor), namely, a number of web page views.

In this instance, when a category of the PV exceeding the predetermined standard exists in the log-in cookie, the advertisement server performs operation S720. That is, the advertisement server performs mapping, with respect to a name of a category of a maximum PV among the categories, a commercial keyword among key words recommended by a search word auto complete function to the category of the maximum PV.

In operation S730, the advertisement server assigns, each keyword advertisement related to the keyword mapped to the category of the maximum PV, a relevancy score indicating relevancy to contents in the target page. That is, the advertisement server calculates CCI of each keyword advertisement using maximum click cost and an advertisement management score, and assigns the relevancy score to each keyword advertisement based on the calculated CCI. In other words, the advertisement server may differently assign the relevancy score to each of top N keyword advertisements with high CCI from among the keyword advertisements.

In operation S740, the advertisement server may display the keyword advertisements in the target page based on the assigned relevancy score. That is, the advertisement server may display the top N keyword advertisements with high relevancy score from among the keyword advertisements in the target page.

In particular, the advertisement server may select the top N (where ‘N’ is a natural number) keyword advertisements from among the keyword advertisements based on the assigned relevancy score. For example, the advertisement server may select the top N (where ‘N’ is a natural number) keyword advertisements with assigned high relevancy score from among the keyword advertisements as advertisements to be displayed in the target page. Next, the advertisement server may display the selected N (where ‘N’ is a natural number) keyword advertisements in the target page.

In this instance, the advertisement server may display the top N keyword advertisements in a predetermined region (e.g. an unsold inventory region of web banner advertisement, a keyword advertisement region excluding an integrated search, and a product search advertisement affiliated region) of the target page. In this instance, the target page may include an internal publisher page (e.g. a page which is not a page of a sub-category, not including a search query, and not a text-based page) or an external publisher page (e.g. news, UCC, an external blog, and the like). Also, the search query may be inputted by the user in a search box of a web page, or alternatively the search query may be stored in the cookie information today.

Accordingly, the advertisement server may display an advertisement with high relevancy to the target page in the target page. Also, the advertisement server displays the advertisement in the unsold inventory region of the web banner advertisement, and the like, thereby effectively using an advertisement inventory and enlarging an advertisement region. Thus, the advertisement server may provide an additional increase of advertisement sales according to the enlargement of the advertisement region.

Also, when the advertisement is displayed in the external publisher page, the advertisement server may share advertising revenue obtained from the displaying with an external publisher who provides the external publisher page.

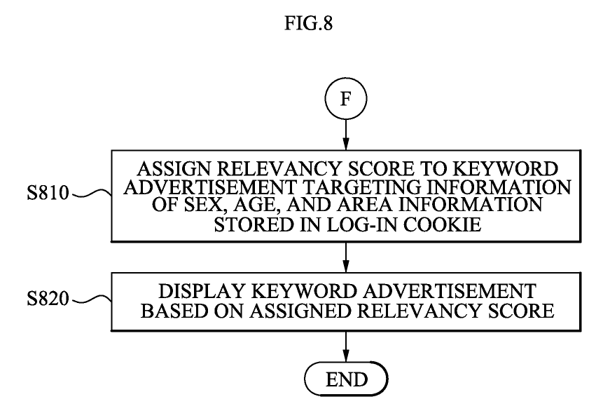

Meanwhile, when the advertisement server verifies that the category of the PV exceeding the predetermined standard does not exist in the log-in cookie in operation S710, the advertisement server performs operations as shown in FIG. 8.

That is, referring to FIG. 8, the advertisement server assign a relevancy score indicating relevancy to contents in the target page to each of keyword advertisements targeting at least one user information of sex, age, and area information stored in the log-in cookie in operation S810. To perform the above, the advertisement server may calculate a CCI of each keyword advertisement using maximum click cost and an advertisement management score, and assign the relevancy score to each keyword advertisement based on the calculated CCI. That is, the advertisement server may differently assign, to top N keyword advertisements with high CCI from among keyword advertisements as display candidates, a relevancy score indicating relevancy to contents in the target page.

In operation S820, the advertisement server may display the keyword advertisements in the target page based on the assigned relevancy score. That is, the advertisement server top N keyword advertisements with high relevancy score from among the keyword advertisements in the target page.

In particular, the advertisement server may select the top N (where ‘N’ is a natural number) keyword advertisements from among the keyword advertisements based on the assigned relevancy score. For example, the advertisement server may select the top N (where ‘N’ is a natural number) keyword advertisements with assigned high relevancy score from among the keyword advertisements as advertisements to be displayed in the target page. Next, the advertisement server may display the selected N (where ‘N’ is a natural number) keyword advertisements in the target page.

In this instance, the advertisement server may display the top N keyword advertisements in a predetermined region (e.g. an unsold inventory region of web banner advertisement, a keyword advertisement region excluding an integrated search, and a product search advertisement affiliated region) of the target page. In this instance, the target page may include an internal publisher page (e.g. a page which is not a page of a sub-category, not including a search query, and not a text-based page) or an external publisher page (e.g. news, UCC, an external blog, and the like). Also, the search query may be inputted by the user in a search box of a web page, or alternatively the search query may be stored in the cookie information today.

Accordingly, the advertisement server may display an advertisement with high relevancy to the target page in the target page. Also, the advertisement server displays the advertisement in the unsold inventory region of the web banner advertisement, and the like, thereby effectively using an advertisement inventory and enlarging an advertisement region. Thus, the advertisement server may provide an additional increase of advertisement sales according to the enlargement of the advertisement region.

Also, when the advertisement is displayed in the external publisher page, the advertisement server may share advertising revenue obtained from the displaying with an external publisher providing the external publisher page.

Meanwhile, according to another example embodiment of the present invention, the advertisement server performs a first selection of advertisements related to a target page from among a product search advertisement, a keyword advertisement, and a web banner advertisement, calculates revenue of the first selected advertisements, and performs a second selection of a predetermined number of advertisements from the first selected advertisements based on the calculated revenue.

For example, the advertisement server integrates the product search advertisement, keyword advertisement, and web banner advertisement and compares their relevancy and revenue and the like so as to select the top N (where ‘N’ is a natural number) advertisements with high relevancy and revenue. In this instance, the advertisement server may select the advertisements by sequentially performing the two selection processes (the first selection and second selection) as described above, or by simultaneously performing the two selection processes (the first selection and second selection).

Next, the advertisement server may display the second selected advertisements in the target page. In this instance, the advertisement server may display the advertisements without distinction of an advertisement region. That is, the advertisement server may display the second selected advertisements in an internal publisher page (e.g. a search page, cafe, blog, and the like) or an external publisher page (e.g. news, UCC, an external blog, and the like).

To perform the above, the advertisement server performs crawling the internal publisher page or external publisher page as the target page, and display the second selected advertisements in the crawled publisher page (either crawled internal publisher page or external publisher page).

Meanwhile, when the second selected advertisements are displayed in the external publisher, the advertisement server may share advertising revenue obtained from the displaying with an external publisher who provides the external publisher page. Through the revenue share model, the advertisement server according to an example embodiment of the present invention may enlarge its advertisement inventory up to an internal publisher page and also up to an external publisher page.

According to example embodiments of the present invention include computer readable recording media storing a program for implementing various operations embodied by a computer. The media may also include, alone or in combination with the program instructions, data files, data structures, and the like. The media and program instructions may be those specially designed and constructed for the purposes of example embodiments, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may be transmission media, such as metallic filaments, waveguides, and the like, which transmit signal to designate program instructions, data structures, and the like. Examples of program instructions include both machine code, such as produced by a compiler, and files containing higher level code that may be executed by the computer using an interpreter.

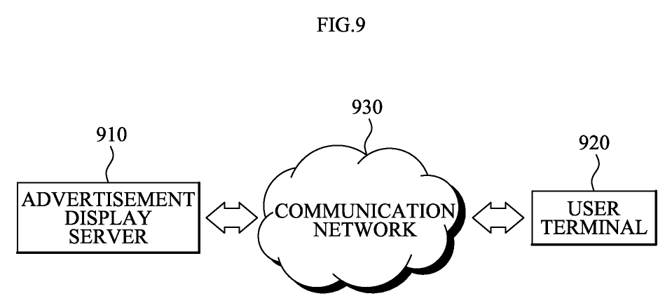

FIG. 9 illustrates a network configuration of an advertisement server which performs displaying advertisement according to an example embodiment.

Referring to FIG. 9, when a user terminal 920 receives a predetermined keyword inputted by a user in a search box of a web page, the user terminal 920 connects with an advertisement server 910 through a communication network 930, and requests a predetermined keyword advertisement according to the keyword from the advertisement server 910. In this instance, the user terminal 920 may include a desk top computer and mobile communication terminal such as a Personal Digital Assistant (PDA), Hand-Held PC, a notebook computer.

Here, the mobile communication terminal includes a portable device with a communication function such as a Personal Digital Cellular (PDC) phone, a Personal Communication Service (PCS) phone, a Personal Handyphone System (PHS) phone, a CDMA-2000(1X, 3X) phone, a Wideband CDMA (WCDMA) phone, a Dual Band/Dual Mode phone, a Global Standard for Mobile (GSM) phone, a Mobile Broadband System (MBS) phone, a Digital Multimedia Broadcasting (DMB) phone, a Smart phone, a hand phone, and the like, a portable terminal, such as a Public Switched Telephone Network (PSTN) terminal, a Voice over Internet Protocol (VoIP), a Session Initiation Protocol (SIP), a Media Gateway Control Protocol (MGCP), a Media Gateway Control (MEGACO), a Personal Digital Assistant (PDA), a Hand-Held PC, a notebook computer, a laptop computer, a WiBro terminal, an MP3 player, MD player, and the like, a portable electric/electronic device which represents all kind of Hand-Held based wireless communication devices including an International mobile Telecommunication-2000 (IMT-2000) terminal that provides international roaming service and expanded mobile communication service, and an Universal mobile Telecommunication Service (UMTS) based terminal.

Also, the mobile communication terminal may contain a predetermined communication module such as a Code Division Multiplexing Access (CDMA) module, a bluetooth module, infrared data association module, a wired and wireless Local Area Network (LAN) card, a Global Positioning System (GPS) chip-contained wireless communication device through which location tracking is possible, and a micro processor which performs a multi-media replay function, thus the mobile communication terminal is commonly known as a terminal which can perform a certain operation.

When the advertisement server 910 receives the request for the predetermined keyword advertisement from the user terminal 920, the advertisement server 910 transmits a keyword advertisement related to the keyword in a product search advertisement, web banner advertisement, or contextual advertisement form to the user terminal 920. Then, the user terminal 920 displays and shows a web page including the keyword advertisement to a user.

The communication network 930 provides a connection between the advertisement server 910 and user terminal 920.

As an example of the communication network 930, a mobile communication network which is a communication between a mobile communication terminal and a fixed point or a communication between mobile communication terminals, to which various mobile communication methods, such as cellular mobile communication method, and the like can be applied. Also, the base station (BS) which relays transmitting/receiving signals of the mobile communication terminal as a wireless station performing communication with a mobile electric/electronic device, a gateway which is a functional unit or apparatus for transmitting/receiving information between communication networks by mutually connecting between a plurality of different or identical communications, and the like are used together with the communication network 930.

The BS, as a wireless station performing communication with the mobile electric/electronic device, is installed on land to relay transmitting/receiving signals of the mobile communication terminal and to perform communication with a land mobile station or communication using a mobile relay station. The BS may include a base station system which constructs the BS in a mobile communication, and the base station system is classified as a Base Station Controller (BCS) and a Base Transceiver Station (BTS), the BSC being in charge of controlling BTS and connecting with every kind of wired network and the BTS being in charge of wireless transmission between a mobile station. Also, the BS of the present invention may be a BS in a radius of a cell where the mobile communication terminal is located, and also be a plurality of BSs related to the mobile communication terminal.

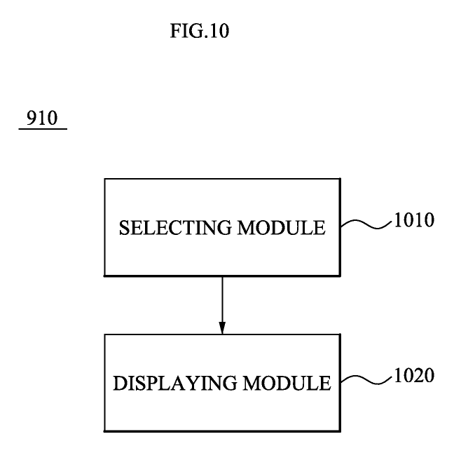

FIG. 10 is a block diagram illustrating the advertisement server of FIG. 9.

Referring to FIG. 9 and FIG. 10, the advertisement server 910 includes a selecting module 1010, and a displaying module 1020.

The selecting module 1010 verifies whether an inputted search query exists. That is, the selecting module 1010 verifies whether the search query is inputted by a user in a search box of a web page that provides search service through a user terminal. Also, the selecting module 1010 verifies whether a shopping query which is subordinate to the search query exists in a target page (document). That is, the selecting module 1010 may read text of the target page and extracts the shopping query from the read text, and thus, the advertisement server can verify whether the shopping query exists through the extracted shopping query.

The displaying module 1020, when the selecting module 1010 verifies that shopping query which is subordinate to the search query exists in the target page, extracts a product search advertisement related to the shopping query. To achieve the above, the displaying module 1020 refers to an advertisement database where a plurality of product search advertisements and shopping queries are mapped and stored, and extracts a product search advertisement related to the shopping query.

The displaying module 1020 selects a product search advertisement from among the extracted product search advertisements. That is, the displaying module 1020 may select the top N product search advertisements from among the extracted product search advertisements in an order of highest relevancy to the shopping query. For example, assuming that 10 product search advertisements related to the shopping query are extracted, the displaying module 1020 selects five product search advertisements from among the extracted 10 product search advertisements in an order of highest relevancy to the shopping query.

The displaying module 1020 assigns, to each of the selected product search advertisements, a relevancy score indicating relevancy to the target page. That is the displaying module 1020 identifies a number of shopping queries according to a type of a shopping query, which is related to the product search advertisement, and existing in the target page, and assigns, based on the number of shopping queries, a relevancy score indicating relevancy to contents in the target page to each of the selected product search advertisements.

The displaying module 1020 displays top N (where ‘N’ is a natural number) product search advertisements from among the product search advertisements in the target page based on the assigned relevancy score. That is, the displaying module 1020 displays top N product search advertisements with assigned high relevancy score in a predetermined region (e.g. an unsold inventory region of web banner advertisement, a keyword advertisement region excluding an integrated search, and a product search advertisement affiliated region) of the target page. In this instance, the target page may include an integrated search result page, a tap search result page, a result page of a search within service.

Accordingly, the advertisement server 910 according to an example embodiment of the present invention displays a product search advertisement with the highest relevancy to the target page in the target page. Also, the advertisement server 910 displays the product search advertisement in the unsold inventory region of the web banner advertisement, and the like, thereby effectively using an advertisement inventory and enlarging an advertisement region. Thus, the advertisement server 910 provides additional increase of advertisement sales according to the enlargement of the advertisement region.

Conversely, the displaying module 1020, when the selecting module 1010 verifies that the shopping query that is subordinate to the search query does not exist in the target page, extracts a keyword advertisement related to the search query. To perform the above, the displaying module 1020 may refer to an advertisement database where a plurality of keyword advertisements and search queries are mapped and stored, and extract the keyword advertisement related to the search query.

The displaying module 1020 selects a keyword advertisement from among the extracted keyword advertisements. That is, the displaying module 1020 may select the top N (where ‘N’ is a natural number) keyword advertisements from among the extracted keyword advertisements in an order of highest relevancy to the search query. For example, assuming that 10 keyword advertisements related to the search query are extracted, the displaying module 1020 selects the top five keyword advertisements from among the extracted 10 keyword advertisements in an order of highest relevancy to the search query.

The displaying module 1020 assigns, to each of the selected keyword advertisements, a relevancy score indicating relevancy to the target page. That is, the displaying module 1020 identifies a number of search queries according to a type of a search query existing in the target page, and assigns, based on the number of search queries, a relevancy score indicating relevancy to contents in the target page to each of keyword advertisements.

Also, alternatively, the displaying module 1020 may calculate a CCI of each keyword advertisement related to the search query using maximum click cost and a score for managing advertisements, and assign, to each of the keyword advertisements, a relevancy score indicating relevancy to contents in the target page based on the calculated CCI.

The displaying module 1020 display the top N (where ‘N’ is a natural number) keyword advertisements in the target page from among the keyword advertisements based on the assigned relevancy score. That is, the displaying module 1020 may display the top N (where ‘N’ is a natural number) keyword advertisements with high relevancy score in a predetermined region (e.g. an unsold inventory region of web banner advertisement, a keyword advertisement region excluding an integrated search, and a product search advertisement affiliated region) of the target page. In this instance, the target page may include an integrated search result page, a tap search result page, a result page of a search within service.

Accordingly, the advertisement server 910 according to an example embodiment of the present invention displays a keyword advertisement with the highest relevancy to the target page in the target page. Also, the advertisement server 910 displays the keyword advertisement in the unsold inventory region of the web banner advertisement, and the like, thereby effectively using an advertisement inventory and enlarging an advertisement region. Thus, the advertisement server 910 provides additional increase of advertisement sales according to the enlargement of the advertisement region.

Meanwhile, the displaying module 1020, when the selecting module 1010 verifies that the search query inputted from the user does not exist, the displaying module 1020 sends a request for an advertisement to a contextual advertisement engine, a product search advertisement engine, a web banner advertisement engine. In this instance, the displaying module 1020 requests advertisements related to contents in the target page from the contextual advertisement engine, product search advertisement engine, and web banner advertisement engine. Also, the displaying module 1020 may request the advertisements from at least one of the contextual advertisement engine, product search advertisement engine, and web banner advertisement engine.

The selecting module 1010 verifies whether the advertisements are returned from the contextual advertisement engine, product search advertisement engine, and web banner advertisement engine in response to the advertisement request. That is, the selecting module 1010 may verify whether a keyword advertisement, a product search advertisement, a web banner advertisement are respectively returned from the contextual advertisement engine, product search advertisement engine, and web banner advertisement engine in response to the advertisement request.

As a result of verifying, when the advertisements are returned, the displaying module 1020 assigns, to the keyword advertisement, product search advertisement, and web banner advertisement, a relevancy score indicating relevancy to contents in the target page. To perform the above, the displaying module 1020 may assign high relevancy score to an advertisement with high relevancy to contents in the target page.

Also, alternatively, the displaying module 1020 may calculate a CCI of each advertisement (a keyword advertisement, a product search advertisement, and a web banner advertisement) returned from the contextual advertisement engine, product search advertisement engine, and web banner advertisement engine using maximum click cost and an advertisement management score, and assign, to each of the advertisements, a relevancy score indicating relevancy to contents in the target page based on the calculated CCI.

The displaying module 1020 may adjust the relevancy score by applying a heuristic rule. That is, the displaying module 1020 compares the assigned relevancy score with a value obtained from experience-based learning (experiential value) to derive a suitable value (relevancy score), thereby adjusting the relevancy score.

Accordingly, the displaying module 1020 may assign to each of the advertisements, a relevancy score which is adjusted to an improved value.

Therefore, the advertisement server 910 may satisfy an environment to display an advertisement with higher relevancy to the target page.

The displaying module 1020 may display the top N (where ‘N’ is a natural number) advertisements from among the advertisements (a keyword advertisement, a product search advertisement, and a web banner advertisement) in the target page based on the assigned relevancy score. That is, the advertisement server 910 may display the top N advertisements including keyword advertisements, product search advertisements, or web banner advertisements in the target page based on each relevancy score of the keyword advertisement, product search advertisement, and web banner advertisement. In this instance, the target page may include a text-based page excluding a search query.

In this case, the displaying module 1020 may display the advertisements in a predetermined region (e.g. an unsold inventory region of web banner advertisement, a keyword advertisement region excluding an integrated search, and a product search advertisement affiliated region) of the target page in an order of highest relevancy score.

Accordingly, the advertisement server 910 may display an advertisement with high relevancy to the target page in the target page. Also, the advertisement server 910 displays the advertisement in the unsold inventory region of the web banner advertisement, and the like, thereby effectively using an advertisement inventory and enlarging an advertisement region. Thus, the advertisement server may provide an additional increase of advertisement sales according to the enlargement of the advertisement region.

Meanwhile, when selecting module 1010 verifies that the advertisement is not returned from the contextual advertisement engine, product search advertisement engine, and web banner advertisement engine, the advertisement server verifies whether a sub-category of a predetermined category exists. In particular, the displaying module 1020 may verify whether a top category has a sub-category more than a Depth 2 level. In this instance, the category may indicate a category related to the target page. For example, the selecting module 1010 may verify whether the top category, ‘news’ category has the sub-category, ‘autos’ category, more than the Depth 2 level.

As a result of verifying, when the sub-category exists, the displaying module 1020 performs mapping, with respect to a name of the sub-category, a keyword recommended by a search word auto complete function to the sub-category. In this instance, the displaying module 1020 may perform mapping a commercial keyword among the recommended keywords to the sub-category.

The displaying module 1020 assigns, to each keyword advertisement related to the mapped keyword, a relevancy score indicating relevancy to contents in the target page. To perform the above, the displaying module 1020 may estimate relevancy between the keyword and the target page through a predetermined algorithm, and assign the relevancy score to each keyword advertisement based on the estimated relevancy. In this instance, the predetermined algorithm may include a relevancy estimation algorithm using a word, a context, a category, and the like.

Also, alternatively, the displaying module 1020 calculates a CCI of each keyword advertisement related to the keyword using maximum click cost and an advertisement management score, and assigns, to each keyword advertisement, a relevancy score indicating relevancy to contents in the target page based on the calculated CCI.

The displaying module 1020 may display the top N (where ‘N’ is a natural number) keyword advertisements from among the keyword advertisements in the target page based on the assigned relevancy score. In this instance, the displaying module 1020 may display the top N keyword advertisements in a predetermined region (e.g. an unsold inventory region of web banner advertisement, a keyword advertisement region excluding an integrated search, and a product search advertisement affiliated region) of the target page. In this instance, the target page may include a page of the sub-category which is not a text-based page and not including a search query.

In particular, the displaying module 1020 may select the top N (where ‘N’ is a natural number) keyword advertisements from among the keyword advertisements based on the assigned relevancy score. For example, the displaying module 1020 may select the top N (where ‘N’ is a natural number) keyword advertisements with assigned high relevancy score from among the keyword advertisements as advertisements to be displayed in the target page. Next, the displaying module 1020 may display the selected N (where ‘N’ is a natural number) keyword advertisements in the target page.

Accordingly, the advertisement server 910 may display an advertisement with high relevancy to the target page in the target page. Also, the advertisement server 910 displays the advertisement in the unsold inventory region of the web banner advertisement, and the like, thereby effectively using an advertisement inventory and enlarging an advertisement region. Thus, the advertisement server 910 may provide an additional increase of advertisement sales according to the enlargement of the advertisement region.

Meanwhile, when the displaying module 1020 verifies that the sub-category of the predetermined category does not exist, the displaying module 1020 verifies whether cookie information exists in a user terminal. In this instance, when the cookie information exists in the user terminal, the selecting module 1010 verifies whether a search query retrieved during today exists in the cookie information.

In this instance, when the search query retrieved today exists in the cookie information, the displaying module 1020 extracts a keyword advertisement as a display candidate related to the search query from a keyword advertisement database, and assigns, to each extracted keyword advertisement, a relevancy score indicating relevancy to contents in the target page. To perform the above, the displaying module 1020 identifies a number of search queries retrieved today according to a type of a search query, the search queries existing in the cookie information, and assigns the relevancy score based on the number of search queries. In this instance, the advertisement display database may indicate a storing device for recording the search queries and corresponding keyword advertisements thereto.

Also, alternatively, displaying module 1020 may calculate a CCI of each keyword advertisement related to the search query using maximum click cost and advertisement management score, and assign the relevancy score to each of the keyword advertisements based on the calculated CCI.

The displaying module 1020 may display the top N (where ‘N’ is a natural number) keyword advertisements from among the keyword advertisements in the target page based on the assigned relevancy score.

In particular, the displaying module 1020 may select the top N (where ‘N’ is a natural number) keyword advertisements from among the keyword advertisements based on the assigned relevancy score. For example, the displaying module 1020 may select the top N (where ‘N’ is a natural number) keyword advertisements with assigned high relevancy score from among the keyword advertisements as advertisements to be displayed in the target page. Next, displaying module 1020 may display the selected N (where ‘N’ is a natural number) keyword advertisements in the target page.

In this instance, the displaying module 1020 may display the N keyword advertisements in a predetermined region (e.g. an unsold inventory region of web banner advertisement, a keyword advertisement region excluding an integrated search, and a product search advertisement affiliated region) of the target page. In this case, the target page may include a page which is not a page of a sub-category, not a text-based page, and not including a search query. Also, the search query may be inputted by the user in a search box of a web page, or alternatively the search query may be stored in the cookie information today.

Accordingly, the advertisement server 910 may display an advertisement with high relevancy to the target page in the target page. Also, the advertisement server 910 may display the advertisement in the unsold inventory region of the web banner advertisement, and the like, thereby effectively using an advertisement inventory and enlarging an advertisement region. Thus, the advertisement server may provide an additional increase of advertisement sales according to the enlargement of the advertisement region.

Meanwhile, when the selecting module 1010 verifies the search query retrieved today does not exist in the cookie information, the selecting module 1010 verifies whether user interest information exists in a log-in cookie stored in a user terminal. In this instance, the log-in cookie may be a log-in cookie that the advertisement server searches by mapping with a browser of the user terminal.

When the interest information exists in the log-in cookie, the displaying module 1020 assigns, to a keyword advertisement related to the user interest information, a relevancy score indicating relevancy to contents in the target page. To perform the above, the displaying module 1020 may extract the user interest information from the log-in cookie, and retrieve the keyword advertisement related to the interest information from a keyword advertisement database using the extracted interest information. Also, displaying module 1020 may assign, to each retrieved keyword advertisement, a relevancy score indicating relevancy to contents in the advertisement target page.

In this instance, the displaying module 1020 may assign the relevancy score to each keyword advertisement in an order of highest interest of user for the user interest information. Also, alternatively, the displaying module 1020 may calculate a CCI of each keyword advertisement using maximum click cost and advertisement management score, and assign the relevancy score to each of the keyword advertisements based on the calculated CCI. That is, the displaying module 1020 may differently assign the relevancy score to each keyword advertisement in an order of highest CCI.

The displaying module 1020 may display the top N (where ‘N’ is a natural number) keyword advertisements from among the keyword advertisements in the target page based on the assigned relevancy score. That is, the displaying module 1020 may display the top N keyword advertisements with high relevancy score from among the keyword advertisements in the target page.

In particular, the displaying module 1020 may select the top N (where ‘N’ is a natural number) keyword advertisements from among the keyword advertisements based on the assigned relevancy score. For example, the displaying module 1020 may select the top N (where ‘N’ is a natural number) keyword advertisements with assigned high relevancy score from among the keyword advertisements as advertisements to be displayed in the target page. Next, the displaying module 1020 may display the selected N (where ‘N’ is a natural number) keyword advertisements in the target page.

In this instance, the displaying module 1020 may display the N keyword advertisements in a predetermined region (e.g. an unsold inventory region of web banner advertisement, a keyword advertisement region excluding an integrated search, and a product search advertisement affiliated region) of the target page. In this case, the target page may include a page which is not a page of a sub-category, not a text-based page, and not including a search query. Also, the search query may be inputted by the user in a search box of a web page, or alternatively the search query may be stored in the cookie information today.

Accordingly, the advertisement server 910 may display an advertisement with high relevancy to the target page in the target page. Also, the advertisement server 910 may display the advertisement in the unsold inventory region of the web banner advertisement, and the like, thereby effectively using an advertisement inventory and enlarging an advertisement region. Thus, the advertisement server 910 may provide an additional increase of advertisement sales according to the enlargement of the advertisement region.

Meanwhile, when selecting module 1010 verifies that user interest information doest not exist in the log-in cookie stored in the user terminal, the selecting module 1010 verifies whether a category of PV exceeding a predetermined standard exists in the log-in cookie. In this instance, the PV indicates how many times a requested web page is viewed to a visitor (a page accessor), namely, a number of web page views.

When a category of the PV exceeding the predetermined standard exists in the log-in cookie, the displaying module 1020 performs mapping, with respect to a name of a category of a maximum PV among the categories, a commercial keyword among key words recommended by a search word auto complete function to the category of the maximum PV.

The displaying module 1020 assigns, each keyword advertisement related to the keyword mapped to the category of the maximum PV, a relevancy score indicating relevancy to contents in the target page. That is, the displaying module 1020 calculates CCI of each keyword advertisement using maximum click cost and an advertisement management score, and assigns the relevancy score to each keyword advertisement based on the calculated CCI. In other words, the displaying module 1020 may differently assign the relevancy score to each of top N keyword advertisements with high CCI from among the keyword advertisements.

The displaying module 1020 may display the keyword advertisements in the target page based on the assigned relevancy score. That is, the displaying module 1020 may display the top N keyword advertisements with high relevancy score from among the keyword advertisements in the target page.

In particular, the displaying module 1020 may select the top N (where ‘N’ is a natural number) keyword advertisements from among the keyword advertisements based on the assigned relevancy score. For example, the advertisement server may select the top N (where ‘N’ is a natural number) keyword advertisements with assigned high relevancy score from among the keyword advertisements as advertisements to be displayed in the target page. Next, the displaying module 1020 may display the selected N (where ‘N’ is a natural number) keyword advertisements in the target page.

In this instance, the displaying module 1020 may display the top N keyword advertisements in a predetermined region (e.g. an unsold inventory region of web banner advertisement, a keyword advertisement region excluding an integrated search, and a product search advertisement affiliated region) of the target page. In this instance, the target page may include a page which is not a page of a sub-category, not a text-based page, and not including a search query. Also, the search query may be inputted by the user in a search box of a web page, or alternatively the search query may be stored in the cookie information today.

Accordingly, the advertisement server 910 may display an advertisement with high relevancy to the target page in the target page. Also, the advertisement server 910 displays the advertisement in the unsold inventory region of the web banner advertisement, and the like, thereby effectively using an advertisement inventory and enlarging an advertisement region. Thus, the advertisement server 910 may provide an additional increase of advertisement sales according to the enlargement of the advertisement region.

Meanwhile, when the displaying module 1020 verifies that the category of the PV exceeding the predetermined standard does not exist in the log-in cookie, the displaying module 1020 assign a relevancy score indicating relevancy to contents in the target page to each of keyword advertisements targeting at least one user information of sex, age, and area information stored in the log-in cookie. To perform the above, the displaying module 1020 calculate a CCI of each keyword advertisement using maximum click cost and an advertisement management score, and assign the relevancy score to each keyword advertisement based on the calculated CCI. That is, the displaying module 1020 may differently assign, to top N keyword advertisements with high CCI from among keyword advertisements as display candidates, a relevancy score indicating relevancy to contents in the target page.

The displaying module 1020 may display the keyword advertisements in the target page based on the assigned relevancy score. That is, the displaying module 1020 top N keyword advertisements with high relevancy score from among the keyword advertisements in the target page.

In particular, the displaying module 1020 may select the top N (where ‘N’ is a natural number) keyword advertisements from among the keyword advertisements based on the assigned relevancy score. For example, the advertisement server may select the top N (where ‘N’ is a natural number) keyword advertisements with assigned high relevancy score from among the keyword advertisements as advertisements to be displayed in the target page. Next, the displaying module 1020 may display the selected N (where ‘N’ is a natural number) keyword advertisements in the target page.

In this instance, the displaying module 1020 may display the top N keyword advertisements in a predetermined region (e.g. an unsold inventory region of web banner advertisement, a keyword advertisement region excluding an integrated search, and a product search advertisement affiliated region) of the target page. In this instance, the target page may include a page which is not a page of a sub-category, not a text-based page, and not including a search query. Also, the search query may be inputted by the user in a search box of a web page, or alternatively the search query may be stored in the cookie information today.

Accordingly, the advertisement server 910 may display an advertisement with high relevancy to the target page in the target page. Also, the advertisement server 910 displays the advertisement in the unsold inventory region of the web banner advertisement, and the like, thereby effectively using an advertisement inventory and enlarging an advertisement region. Thus, the advertisement server 910 may provide an additional increase of advertisement sales according to the enlargement of the advertisement region.

Meanwhile, according to another example embodiment of the present invention, although not illustrated in drawings, the advertisement server 910 may include a selecting module and displaying module.

The selecting module performs a first selection of advertisements related to a target page from among a product search advertisement, keyword advertisement, or web banner advertisement, calculates revenue of the first selected advertisements, and performs a second selection of a predetermined number of advertisements from the first selected advertisements based on the calculated revenue.

For example, the selecting module integrates the product search advertisement, keyword advertisement, and web banner advertisement and compares their relevancy and revenue and the like so as to select the top N (where ‘N’ is a natural number) advertisements with high relevancy and revenue. In this instance, the advertisement server may select the advertisements by sequentially performing the two selection processes (the first selection and second selection) as described above, or by simultaneously performing the two selection processes (the first selection and second selection).

The displaying module may display the second selected advertisements in the target page. In this instance, the displaying module may display the advertisements without distinction of an advertisement region. That is, the displaying module may display the second selected advertisements in an internal publisher page (e.g. a search page, cafe, blog, and the like) or an external publisher page (e.g. news, UCC, an external blog, and the like).

When the second selected advertisements are displayed in the external publisher, the advertisement server may share advertising revenue obtained from the displaying with an external publisher who provides the external publisher page. Through the revenue share model, the advertisement server according to an example embodiment of the present invention may enlarge its advertisement inventory up to an internal publisher page and also up to an external publisher page.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. Section 112, sixth paragraph, unless the element is expressly recited using the phrase “means for” or, in the case of a method claim, the element is recited using the phrase “step for.”

What is claimed is:

1. A method for displaying an advertisement, the method comprising the steps of:
selecting at least one advertisement that is relevant to a target page based on a predetermined rule among advertisements from at least one contextual advertisement database and at least one keyword advertisement database;
determining advertising revenue derived from each of the first selected advertisement during a predetermined period of time;
selecting at least one advertisement among the first selected advertisement based on the advertising revenue; and
displaying the second selected advertisement in the target page.

2. The method of claim 1, wherein the target page comprises an internal publisher page or an external publisher page.

3. The method of claim 2, when the second selected advertisement is displayed in the external publisher page, further comprising the steps of:
sharing advertising revenue obtained from the displaying with an external publisher for the external publisher page.

4. The method of claim 1, wherein the step of selecting at least one advertisement that is relevant to a target page based on a predetermined rule comprises the steps of:
upon receipt of a search request including at least one search query from a user, extracting at least one predetermined query from the at least one search query; and
analyzing the target page to determine whether the target page matches with the predetermined query included in the search query.

5. The method of claim 1, the step of selecting at least one advertisement that is relevant to a target page based on a predetermined rule further comprises the step of:
assigning to each of the first selected advertisement, a relevancy score indicating a relevancy of the advertisement to the target page; and
selecting at least one advertisement based on the assigned relevancy score.

6. The method of claim 1, wherein the step of displaying comprises the step of:
displaying the second selected advertisement in at least one of an unsold inventory region of a web banner advertisement, a keyword advertisement region excluding an integrated search, and a product search advertisement affiliated region.

7. The method of claim 1, wherein the step of selecting at least one advertisement that is relevant to a target page based on a predetermined rule comprises the step of:
selecting the at least one advertisement corresponding to a category or sub-category of the target page.

8. The method of claim 7, wherein the step of selecting the at least one advertisement corresponding to a category or sub-category of the target page comprises the steps of:
mapping, with respect to a name of the sub-category, a predetermined keyword recommend by a search word auto complete function to the sub-category;
assigning to each of advertisements related to the mapped keyword, a relevancy score indicating relevancy of the advertisement to the target page; and
selecting a predetermined number of advertisements based on the assigned relevancy score.

9. The method of claim 1, wherein the step of selecting at least one advertisement that is relevant to a target page based on a predetermined rule comprises the step of:
verifying whether cookie information exists in a user terminal;
identifying at least one search query retrieved during a predetermined period in the cookie information; and
selecting at least one keyword advertisement related to the search query.

10. The method of claim 9, wherein the step of selecting the keyword advertisement comprises the steps of:
assigning, to each of the keyword advertisements related to the search query, a relevancy score indicating relevancy of the keyword advertisement to the target page; and
selecting a predetermined number of keyword advertisements based on the assigned relevancy score.

11. The method of claim 1, wherein the step of selecting at least one advertisement that is relevant to a target page based on a predetermined rule comprises the step of:
verifying whether a category of a page view exceeding a predetermined standard exists in the log-in cookie;
mapping, when a category of a page view exceeding a predetermined standard exists, a predetermined keyword recommend by a search word auto complete function to the category, with respect to a name of a category of a maximum page view among the categories;
assigning, to each of the keyword advertisements related to the mapped keyword, a relevancy score indicating relevancy of the keyword advertisement to the target page; and
selecting a predetermined number of keyword advertisements based on the assigned relevancy score.

12. The method of claim 1, wherein the contextual advertisement database includes a web banner ad database and the keyword advertisement database includes a product search advertisement database.

13. A method for displaying an advertisement, the method comprising the steps of:
selecting at least one advertisement that is relevant to a target page based on a predetermined rule among advertisements from at least one contextual advertisement database and at least one keyword advertisement database; and
displaying a predetermined number of the first selected advertisement in the target page, wherein the target page is an external publisher page.

14. The method of claim 13, further comprising the step of:
sharing advertising revenue obtained from the displaying with an external publisher for the external publisher page.

15. The method of claim 13, wherein the step of selecting at least one advertisement that is relevant to a target page based on a predetermined rule comprises the steps of:
upon receipt of a search request including at least one search query from a user, extracting at least one predetermined query from the at least one search query; and
analyzing the target page to determine whether the target page matches with the predetermined query included in the search query.

16. The method of claim 13, the step of selecting at least one advertisement that is relevant to a target page based on a predetermined rule further comprises the step of:
assigning to each of the first selected advertisement, a relevancy score indicating a relevancy of the advertisement to the target page; and
selecting at least one advertisement based on the assigned relevancy score.

17. The method of claim 13, wherein the step of displaying comprises the step of:
displaying the second selected advertisement in at least one of an unsold inventory region of a web banner advertisement, a keyword advertisement region excluding an integrated search, and a product search advertisement affiliated region.

18. The method of claim 13, wherein the step of selecting at least one advertisement that is relevant to a target page based on a predetermined rule comprises the step of:
selecting the at least one advertisement corresponding to a category or sub-category of the target page.

19. The method of claim 18, wherein the step of selecting the at least one advertisement corresponding to a category or sub-category of the target page comprises the steps of:
mapping, with respect to a name of the sub-category, a predetermined keyword recommend by a search word auto complete function to the sub-category;
assigning to each of advertisements related to the mapped keyword, a relevancy score indicating relevancy of the advertisement to the target page; and
selecting a predetermined number of advertisements based on the assigned relevancy score.

20. The method of claim 13, wherein the step of selecting at least one advertisement that is relevant to a target page based on a predetermined rule comprises the step of:
verifying whether cookie information exists in a user terminal;
identifying at least one search query retrieved during a predetermined period in the cookie information; and
selecting at least one keyword advertisement related to the search query.

21. The method of claim 20, wherein the step of selecting the keyword advertisement comprises the steps of:
assigning, to each of the keyword advertisements related to the search query, a relevancy score indicating relevancy of the keyword advertisement to the target page; and
selecting a predetermined number of keyword advertisements based on the assigned relevancy score.

22. The method of claim 13, wherein the step of selecting at least one advertisement that is relevant to a target page based on a predetermined rule comprises the step of:
verifying whether a category of a page view exceeding a predetermined standard exists in the log-in cookie;
mapping, when a category of a page view exceeding a predetermined standard exists, a predetermined keyword recommend by a search word auto complete function to the category, with respect to a name of a category of a maximum page view among the categories;
assigning, to each of the keyword advertisements related to the mapped keyword, a relevancy score indicating relevancy of the keyword advertisement to the target page; and
selecting a predetermined number of keyword advertisements based on the assigned relevancy score.

23. The method of claim 13, wherein the contextual advertisement database includes a web banner ad database and the keyword advertisement database includes a product search advertisement database.

24. A system for displaying advertisement, comprising:
a processor;
a memory to communicate with the processor;
a selecting module, resident in the memory and executable by the processor, configured to select at least one advertisement that is relevant to a target page based on a predetermined rule among advertisements from at least one contextual advertisement database and at least one keyword advertisement database, to determine advertising revenue derived from each of the first selected advertisement during a predetermined period of time, and to select at least one advertisement among the first selected advertisement based on the advertising revenue; and
a displaying module, resident in the memory and executable by the processor, configured to display the second selected advertisements in the target page.

25. The system of claim 24, wherein, when the second selected advertisements are displayed in an external publisher page, the displaying module shares advertising revenue obtained from the displaying with an external publisher.

26. The system of claim 24, wherein the selecting module, upon receipt of a search request including at least one search query from a user, extracts at least one predetermined query from the at least one search query and analyzes the target page to determine whether the target page matches with the predetermined query included in the search query.

27. The method of claim 24, the selecting module assigns to each of the first selected advertisement, a relevancy score indicating a relevancy of the advertisement to the target page and selects at least one advertisement based on the assigned relevancy score.

28. The system of claim 24, wherein the displaying module displays the second selected advertisement in at least one of an unsold inventory region of a web banner advertisement, a keyword advertisement region excluding an integrated search, and a product search advertisement affiliated region.

30. A system for displaying an advertisement, comprising:
a processor;
a memory to communicate with the processor;
a selecting module, resident in the memory and executable by the processor, configured to select at least one advertisement that is relevant to a target page based on a predetermined rule among advertisements from at least one contextual advertisement database and at least one keyword advertisement database; and
a displaying module, resident in the memory and executable by the processor, configured to display a predetermined number of the first selected advertisement in the target page, wherein the target page is an external publisher page.

31. The system of claim 30, wherein the selecting module, upon receipt of a search request including at least one search query from a user, extracts at least one predetermined query from the at least one search query and analyzes the target page to determine whether the target page matches with the predetermined query included in the search query.

32. The method of claim 30, wherein the selecting module assigns to each of the first selected advertisement, a relevancy score indicating a relevancy of the advertisement to the target page and selects at least one advertisement based on the assigned relevancy score.

33. The system of claim 30, wherein the displaying module displays the second selected advertisement in at least one of an unsold inventory region of a web banner advertisement, a keyword advertisement region excluding an integrated search, and a product search advertisement affiliated region.

34. The method of claim 30, wherein the selecting module selects the at least one advertisement corresponding to a category or sub-category of the target page.

35. The method of claim 30, wherein the selecting module verifies whether cookie information exists in a user terminal, identifies at least one search query retrieved during a predetermined period in the cookie information and selects at least one keyword advertisement related to the search query.

36. The method of claim 30, wherein the selecting module verifies whether a category of a page view exceeding a predetermined standard exists in the log-in cookie, maps, when a category of a page view exceeding a predetermined standard exists, a predetermined keyword recommend by a search word auto complete function to the category, with respect to a name of a category of a maximum page view among the categories, assigns to each of the keyword advertisements related to the mapped keyword, a relevancy score indicating relevancy of the keyword advertisement to the target page, and selects a predetermined number of keyword advertisements based on the assigned relevancy score.

37. The method of claim 30, wherein the contextual advertisement database includes a web banner ad database and the keyword advertisement database includes a product search advertisement database.

38. One or more computer-readable media having stored thereon a computer program that, when executed by one or more processors, causes the one or more processors to perform acts including:
selecting at least one advertisement that is relevant to a target page based on a predetermined rule among advertisements from at least one contextual advertisement database and at least one keyword advertisement database; and
displaying a predetermined number of the first selected advertisement in the target page, wherein the target page is an external publisher page.
